(19) United States
(12) Patent Application Publication
(10) Pub. No.: US 2026/0220444 A1
(43) Pub. Date: Jul. 30, 2026

(54) QUANTIZATION FOR ARTIFICIAL INTELLIGENCE/MACHINE LEARNING MODELS

(71) Applicant: MEDIATEK INC., Hsinchu City (TW)

(72) Inventors: Pedram KHEIRKHAH SANGDEH, San Jose, CA (US); Gyu Bum KYUNG, San Jose, CA (US)

(21) Appl. No.: 19/149,208

(22) PCT Filed: Feb. 18, 2024
(86) PCT No.: PCT/CN2024/077357

§ 371 Date: Jul. 18, 2025

Related U.S. Application Data
(60) Provisional application No. 63/485,557, filed on Feb. 17, 2023.

(51) Int. Cl. G06N 3/0495; G06N 3/0455

(52) U.S. Cl. CPC G06N 3/0495; G06N 3/0455

(57) ABSTRACT

Techniques pertaining to quantization for artificial intelligence and machine learning (AI/ML) models in wireless communications are described. An apparatus performs quantization with respect to an AI/ML model. The apparatus then performs a wireless communication by utilizing the AI/ML model.

### CROSS REFERENCE TO RELATED PATENT APPLICATION(S)

The present disclosure is part of a non-provisional application claiming the priority benefit of U.S. Patent Application No. 63/485,557, filed 17 Feb. 2023, the content of which herein being incorporated by reference in its entirety.

### TECHNICAL FIELD

The present disclosure is generally related to wireless communications and, more particularly, to quantization for artificial intelligence and machine learning (AI/ML) models in wireless communications.

### BACKGROUND

Unless otherwise indicated herein, approaches described in this section are not prior art to the claims listed below and are not admitted as prior art by inclusion in this section.

In a communication system, such as wireless communications in accordance with the 3^{rd} Generation Partnership Project (3GPP) standards, many functions on the user equipment (UE) side tend to have a corresponding twin on the network side, and vice versa. In the context of AI/ML, this may be referred to as a two-sided AI/ML model, also known as autoencoders. However, as the real world is constituted by an analog and continuous time-space environment, training of an AI/ML model may require and/or result in an extremely large amount of data, including latent vectors and gradient vectors among others. Such huge amount of data would be overburdening if not overwhelming to both the UE side and the network side. Therefore, there is a need for a solution of quantization of data for AI/ML models in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to quantization for AI/ML models in wireless communications. It is believed that implementations of the various proposed schemes may address or otherwise alleviate the aforementioned issue(s). The various schemes proposed herein may be utilized in a variety of applications and scenarios such as, for example and without limitation, channel state information (CSI) compression, denoising (or noise reduction), quantization, modulation, peak-to-average power ratio (PAPR) reduction, and image compression.

In one aspect, a method may involve performing quantization with respect to an AI/ML model. The method may also involve performing a wireless communication by utilizing the AI/ML model.

In another aspect, an apparatus may include a transceiver configured to communicate wirelessly and a processor coupled to the transceiver. The processor may perform quantization with respect to an AI/ML model. The processor may also perform a wireless communication by utilizing the AI/ML model.

It is noteworthy that, although description provided herein may be in the context of certain radio access technologies, networks, and network topologies for wireless communication, such as 5^{th} Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example scenario in accordance with an implementation of the present disclosure.

FIG. 6 is a diagram of an example scenario in accordance with an implementation of the present disclosure.

FIG. 7 is a diagram of an example scenario in accordance with an implementation of the present disclosure.

FIG. 8 is a diagram of an example scenario in accordance with an implementation of the present disclosure.

FIG. 9 is a diagram of an example scenario in accordance with an implementation of the present disclosure.

FIG. 10 is a diagram of an example scenario in accordance with an implementation of the present disclosure.

FIG. 11 is a block diagram of an example communication system in accordance with an implementation of the present disclosure.

FIG. 12 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to quantization for AI/ML models in wireless communications. According to the present disclosure, a number of possible solutions may be implemented separately or jointly. That is, although these possible solutions may be described below separately, two or more of these possible solutions may be implemented in one combination or another.

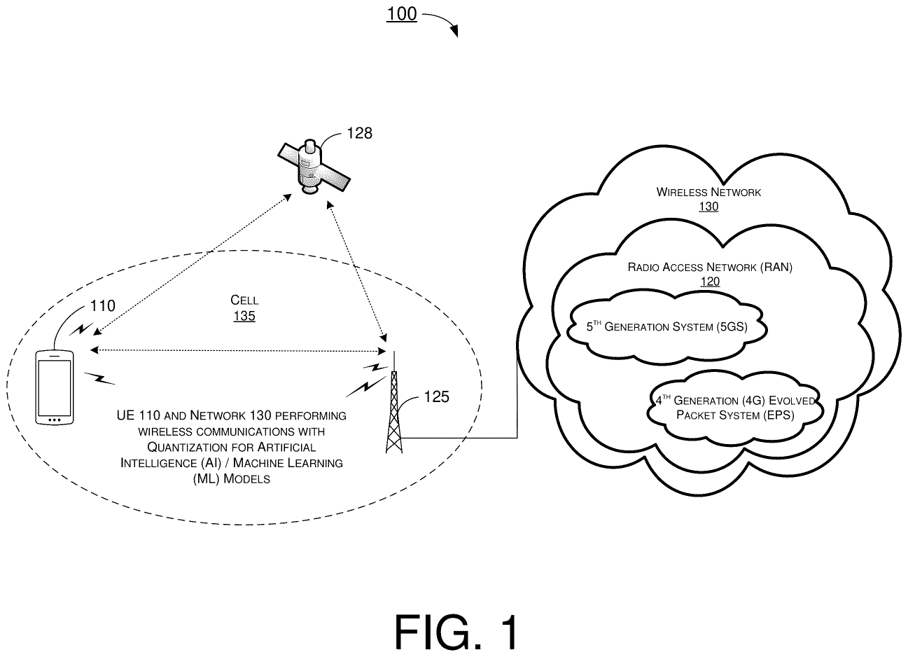

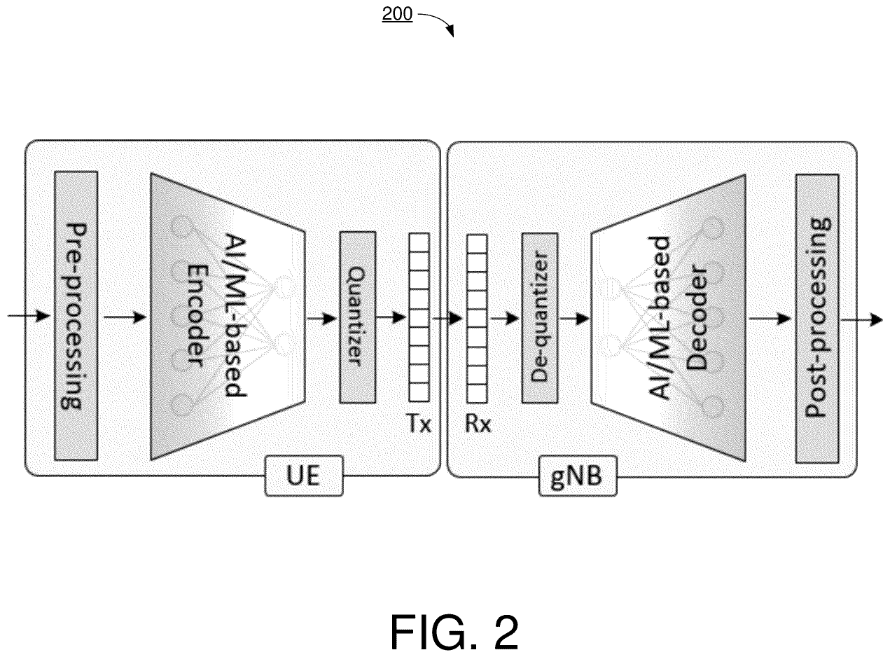

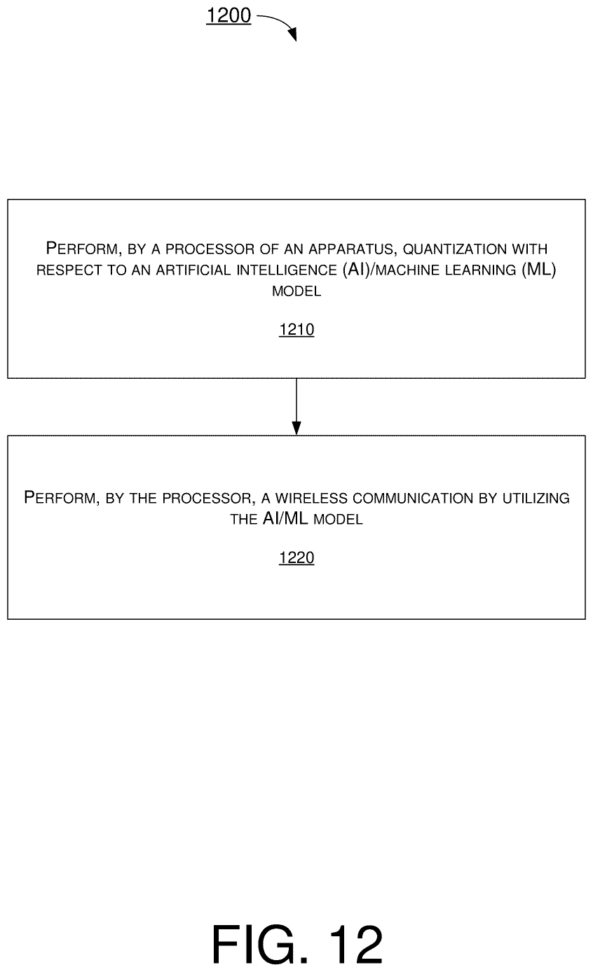

FIG. 1 illustrates an example network environment 100 in which various solutions and schemes in accordance with the present disclosure may be implemented. FIG. 2~FIG. 12 illustrate examples of implementation of various proposed schemes in network environment 100 in accordance with the present disclosure. The following description of various proposed schemes is provided with reference to FIG. 1~FIG. 12.

Referring to FIG. 1, network environment 100 may involve a UE 110 in wireless communication with a radio access network (RAN) 120 (e.g., a 5G NR mobile network or another type of network such as a non-terrestrial network (NTN)). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a network 130. In network environment 100, UE 110 and network 130 (via terrestrial network node 125 and/or non-terrestrial network node 128) may implement various schemes pertaining to quantization for AI/ML models in wireless communications, as described below. In the present disclosure, the two-sided AI/ML model may be under training for the application of CSI compression, noise reduction, quantization, modulation, PAPR reduction, and/or image compression. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under various proposed schemes in accordance with the present disclosure, a continuous space may be discretized into a finite number of representative points. Additionally, each of the representative points may be indexed with a finite number of bits. Under the proposed schemes, quantization in a latent space may compact representation of one or more latent vectors in a forward pass of a training stage and an inference stage of an AI/ML model. Moreover, quantization in a gradient space may compact representation of one or more gradient vectors in a backpropagation of the training stage of the AI/ML model. Furthermore, quantization in a data space may help facilitate a data collection procedure by lowering its overhead via compacting samples.

FIG. 2 illustrates an example scenario 200 of a framework of quantization in the latent space under a proposed scheme in accordance with the present disclosure. Under the proposed scheme, quantization in the latent space may be two-sided and may involve a quantization side and de-a quantization side. It is noteworthy that, although the example shown in FIG. 2 pertains to CSI compression, the proposed scheme may also be utilized in other applications (e.g., noise reduction, quantization, modulation, PAPR reduction, and/or image compression). Under the proposed scheme, the quantization side may involve two steps, namely a first step (step 1) and a second step (step 2). At step 1, a CSI generation part of the AI/ML model may construct a latent vector. At step 2, one or more quantizer modules may convert continuous latent vectors into a finite number of bits of a bit stream. Under the proposed scheme, the dequantization side may also involve two steps, namely a first step (step 1) and a second step (step 2). At step 1, a dequantizer may recover the latent vectors from the bit stream. At step 2, a CSI reconstruction part of the AI/ML model may recover CSI from the latent vectors.

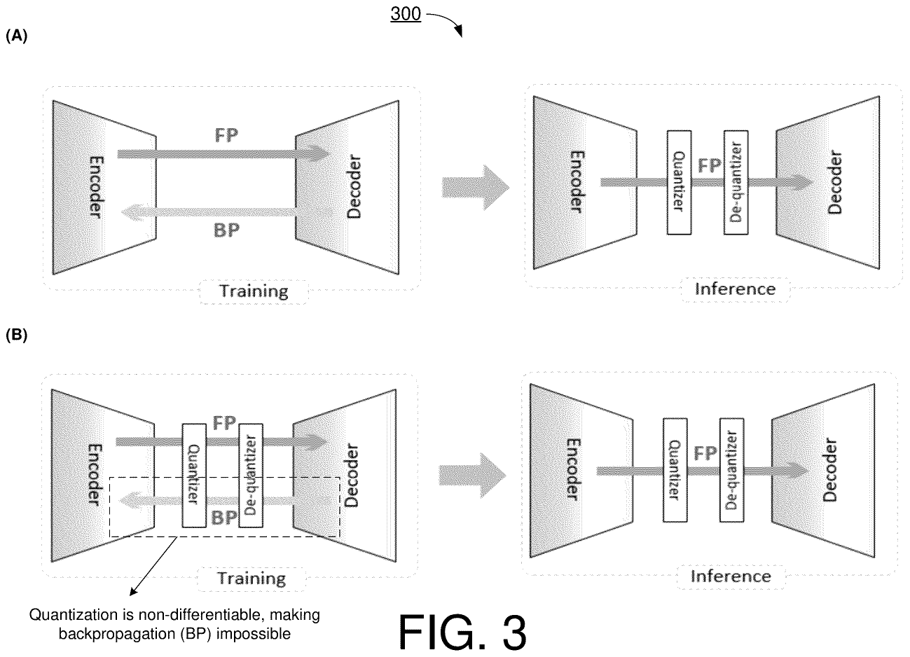

FIG. 3 illustrates an example scenario 300 of training awareness of quantization in the latent space under a proposed scheme in accordance with the present disclosure. Under the proposed scheme, quantization may be either training aware or training non-aware. Part (A) of FIG. 3 shows an example of training-non-aware (TNA) quantization under the proposed scheme, and part (B) of FIG. 3 shows an example of training-aware (TA) quantization under the proposed scheme. Under TNA quantization, the AI/ML model may only be exposed to quantization methods in the forward pass (FP) of an inference stage. Under TA quantization, the AI/ML model may only be exposed to quantization methods in the inference stage. This is because, as quantization is non-differentiable in the training stage, backpropagation (BP) is rendered impossible.

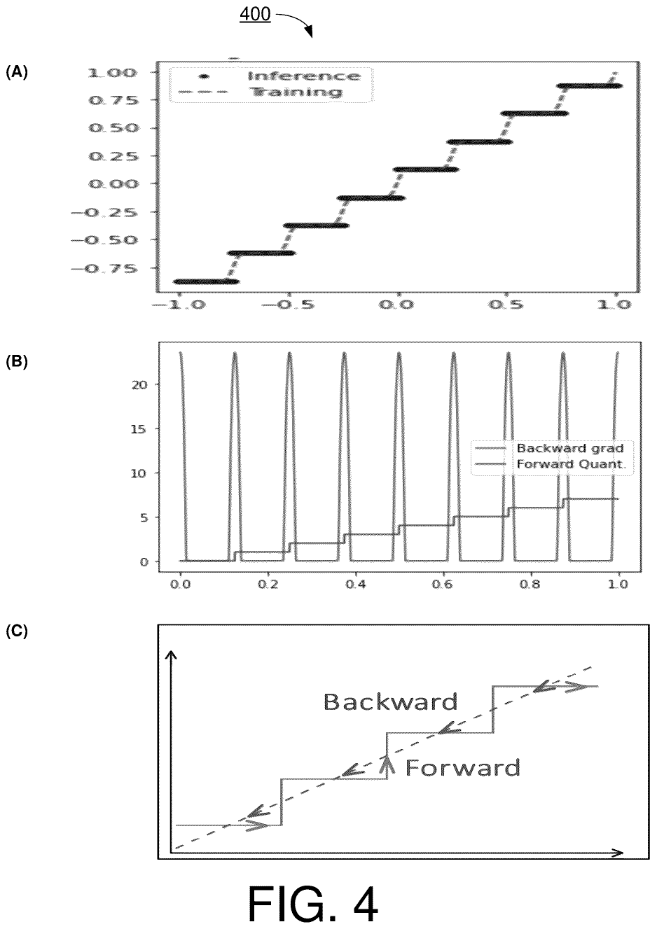

FIG. 4 illustrates an example scenario 400 of training awareness of quantization in the latent space under a proposed scheme in accordance with the present disclosure. Under the proposed scheme, training awareness of quantization in backpropagation may be raised by one or more approaches. A first approach may involve approximation of a quantization function with differentiable functions, as shown in part (A) of FIG. 4. Accordingly, the BP may be secured given the differentiability of the quantization function. A second approach may involve approximation of the gradient of the quantization function, as shown in part (B) of FIG. 4. Accordingly, the BP may be approximated only at the non-differentiable points. A third approach may involve artificial gradient for quantization, as shown in part (C) of FIG. 4. For instance, the gradient of the quantization function may be replaced with a constant over its entire domain.

Under a proposed scheme in accordance with the present disclosure, learnability with respect to quantization in the latent space may imply whether quantization parameters and/or configurations may change in the course of training stage. Accordingly, learnability is a unique feature of TA quantization methods. Examples of learnability of quantization may include learnable clipper, learnable transformation on input/output (I/O) of quantization, learnable quantization levels, and learnable quantization intervals. A learnable quantization may pose configuration and parameters which may be adjusted during the training stage. Examples of non-learnability (NL) of quantization may include fixed uniform quantization the intervals and levels of which may remain unchanged during the training stage.

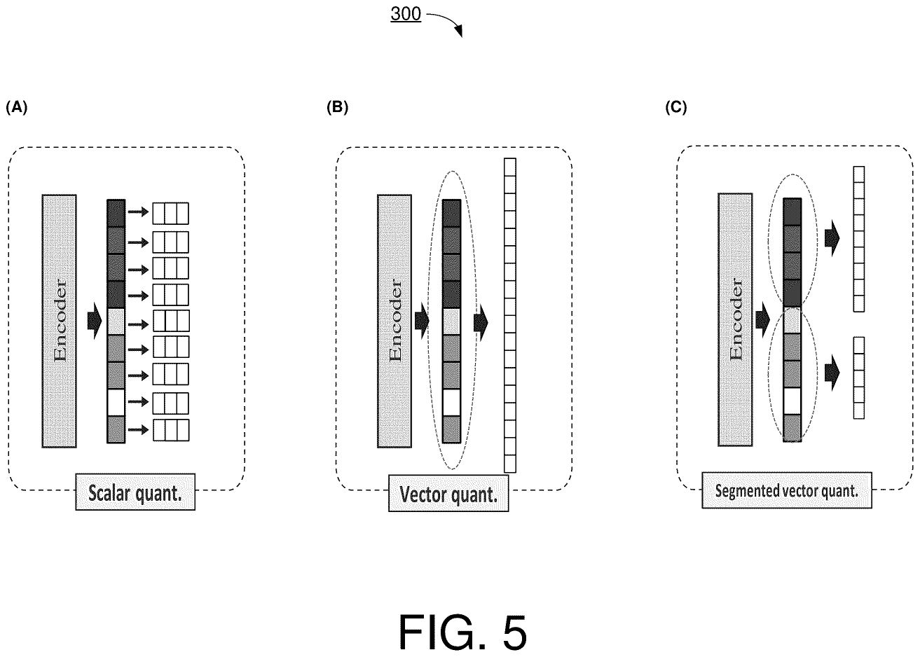

FIG. 5 illustrates an example scenario 500 of codeword assignment of quantization in the latent space under a proposed scheme in accordance with the present disclosure. Under the proposed scheme, mapping of codeword assignments may involve one or more of the following: scalar quantization (SQ), vector quantization (VQ) and segmented vector quantization. Part (A) of FIG. 5 shows an example of SQ, part (B) of FIG. 5 shows an example of VQ, and part (C) of FIG. 5 shows an example of segmented vector quantization. Under the proposed scheme, SQ may involve mapping an element on a latent vector to a new discretized element, one by one. Moreover, VQ may involve mapping a latent vector to a new discretized vector. Furthermore, segmented vector quantization may involve breaking down a latent vector into multiple segments, with each segment being subjected to the VQ.

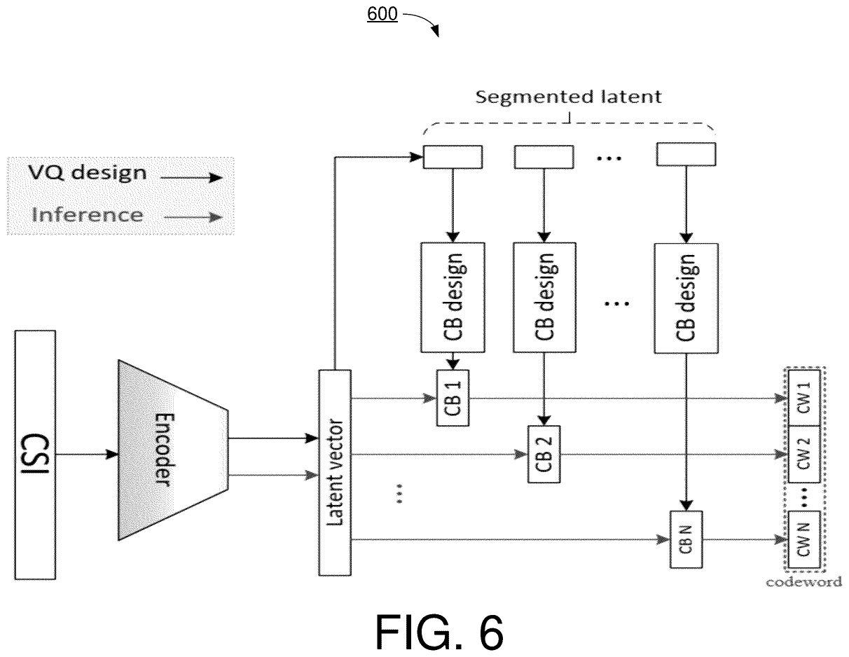

FIG. 6 illustrates an example scenario 600 of segmentation of vector quantization in the latent space under a proposed scheme in accordance with the present disclosure. Under the proposed scheme, segmentation may be performed before VQ. The reason for segmentation before VQ is that codebook design for VQ is computationally expensive and its complexity tends to increase with dimensions of its input. Thus, segmentation helps with dimension reduction. Additionally, the number of CSI samples in training dataset may exceed the number of representative points, which may be too large without segmentation. Thus, segmentation may relax the excessive need for training data. Referring to FIG. 6, in a segmented VQ framework under the proposed scheme, training latent points may be broken down to smaller segments, with a respective VQ codebook designed per segment. The same segmentation may be applied in the inference stage, and a respective codebook may be assigned to each segment in the inference stage. The codewords of all segments in the inference stage may be concatenated into a final codeword, and the final codeword may be mapped into a bit stream.

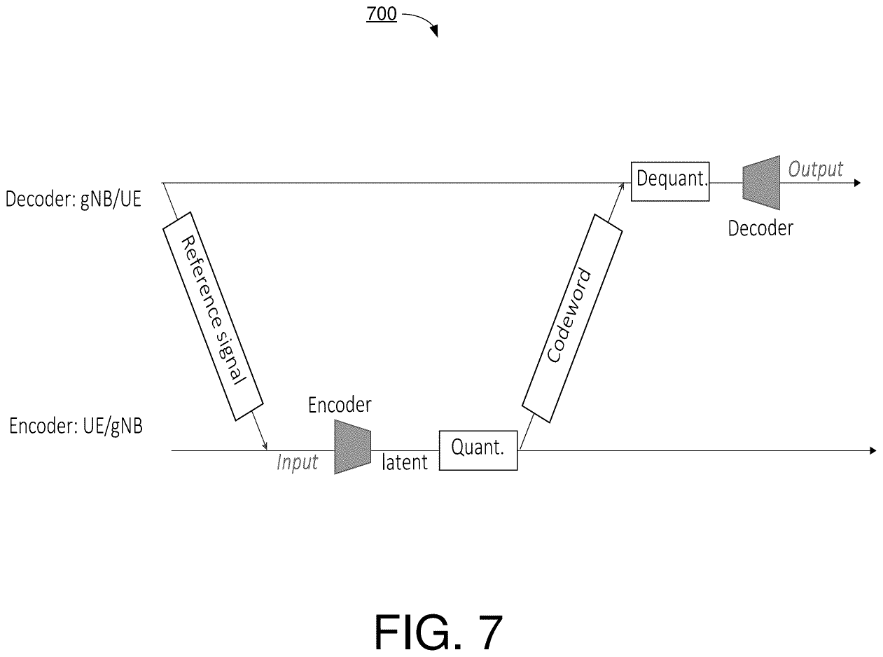

FIG. 7 illustrates an example scenario 700 of inference with respect to quantization in the latent space under a proposed scheme in accordance with the present disclosure. Under the proposed scheme, inference of a two-sided AI/ML model with latent quantization may involve a number of steps, as shown in FIG. 7. At a first step (step 1), an input may be measured and fed to an encoder. At a second step (step 2), an original latent may be resulted at an output of the encoder. At a third step (step 3), quantization may be applied to the latent, and a codeword may be generated and sent to a decoder. At a fourth step (step 4), the codeword may be dequantized. At a fifth step (step 5), the dequantized codeword may be fed to the decoder and a desired output may be generated.

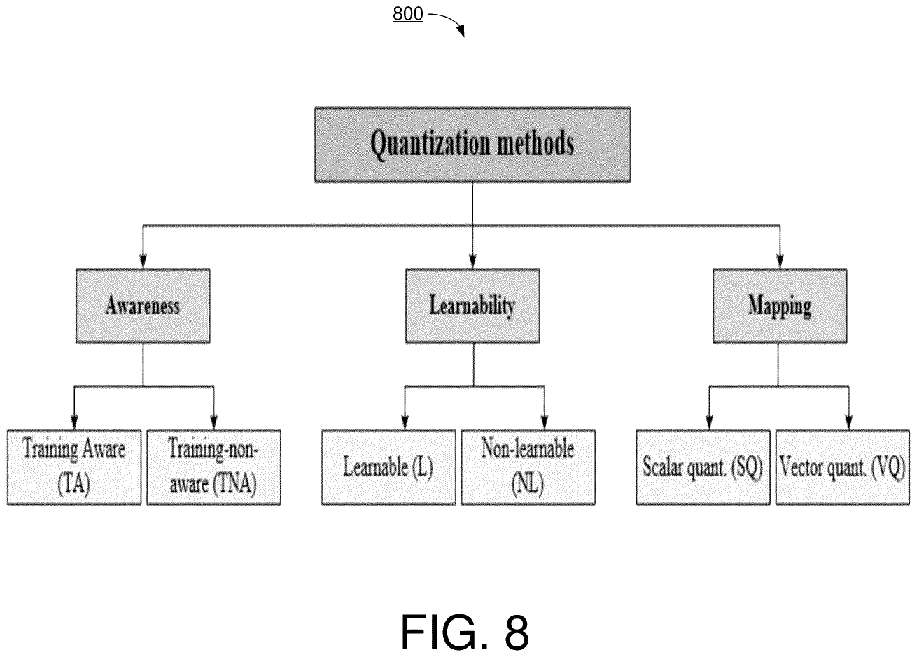

FIG. 8 illustrates an example scenario 800 of classification of quantization approaches under a proposed scheme in accordance with the present disclosure. Under the proposed scheme, quantization approaches may be classified in terms of training awareness, learnability and mapping (or codeword assignment), as shown in FIG. 8. Such classification may provide a comprehensive description of any quantization method.

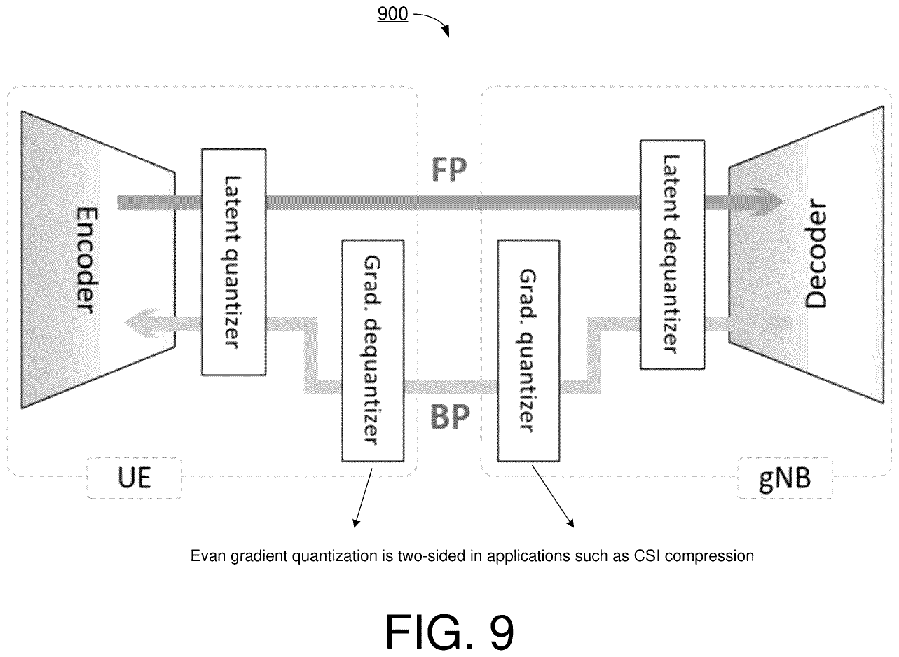

FIG. 9 illustrates an example scenario 900 of quantization in a gradient space under a proposed scheme in accordance with the present disclosure. Under the proposed scheme, in case that a BP loop crosses through two entities (e.g., UE and gNB), the gradient may be exchanged as well. The gradient may impose a large overhead to communication infrastructure and thus should be quantized. Under the proposed scheme, gradient quantization may be required for BP which is not necessarily the same as the latent quantizer. In the example shown in FIG. 9, even gradient quantization is two-sided for CSI compression.

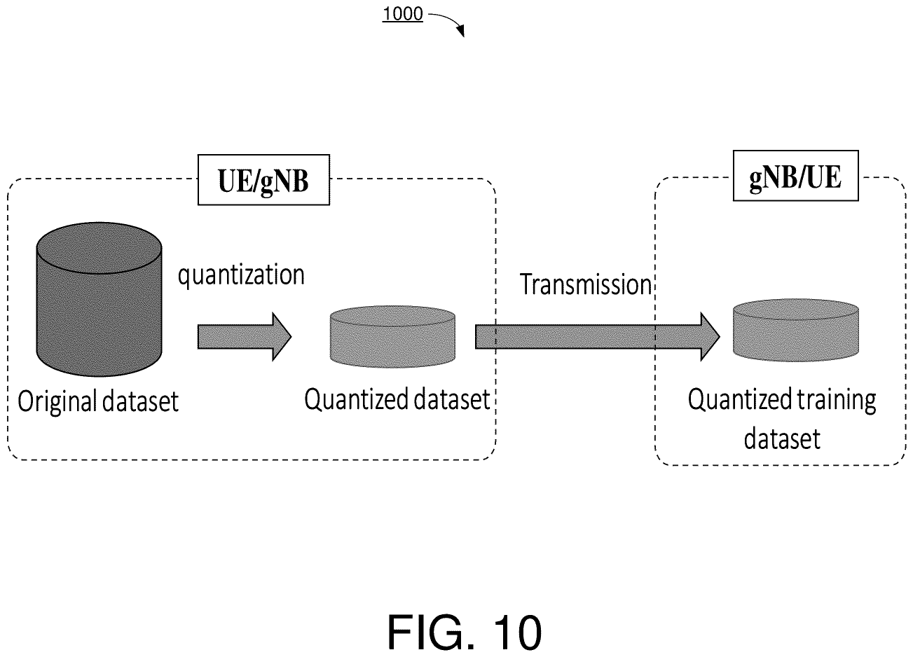

FIG. 10 illustrates an example scenario 1000 of quantization in data collection under a proposed scheme in accordance with the present disclosure. Data collection may include collecting data by UE and/or network (e.g., gNB) and sending the collected data to the other side. Each sample may come with a variety of assistant information and would be accumulated over time. Accordingly, the resultant overhead may be excessively large. Under the proposed scheme, quantization may also be implemented during the data collection phase, as shown in FIG. 10.

### Illustrative Implementations

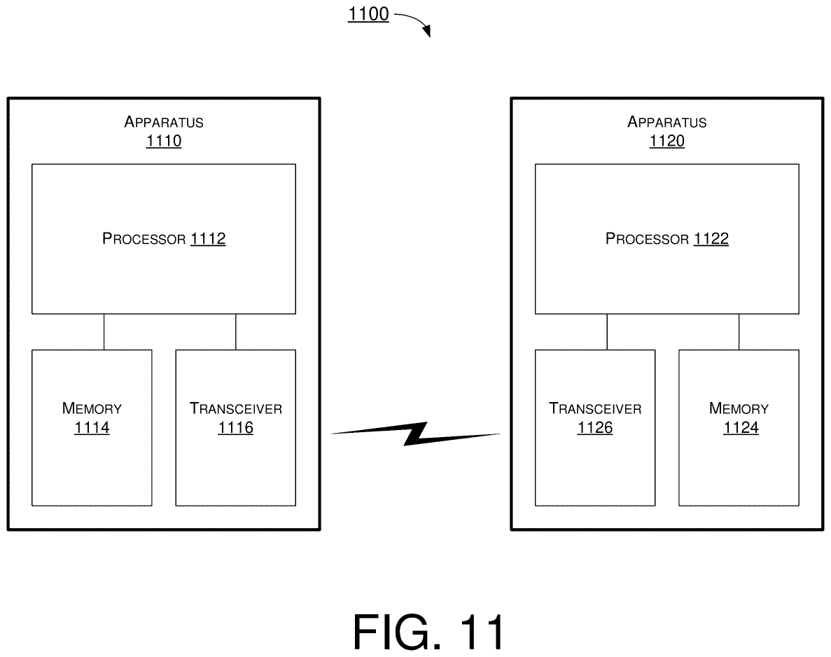

FIG. 11 illustrates an example communication system 1100 having at least an example apparatus 1110 and an example apparatus 1120 in accordance with an implementation of the present disclosure. Each of apparatus 1110 and apparatus 1120 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 1110 and apparatus 1120 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 1110 and apparatus 1120 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 1110 and apparatus 1120 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 1110 and apparatus 1120 may be implemented in a smart thermostat, a smart fridge, a smart door lock, a wireless speaker or a home control center. When implemented in or as a network apparatus, apparatus 1110 and/or apparatus 1120 may be implemented in an eNodeB in an LTE, LTE-Advanced or LTE-Advanced Pro network or in a gNB or TRP in a 5G network, an NR network or an IoT network.

In some implementations, each of apparatus 1110 and apparatus 1120 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 1110 and apparatus 1120 may be implemented in or as a network apparatus or a UE. Each of apparatus 1110 and apparatus 1120 may include at least some of those components shown in FIG. 11 such as a processor 1112 and a processor 1122, respectively, for example. Each of apparatus 1110 and apparatus 1120 may further include one or more other components not pertinent to the proposed scheme of the present disclosure (e.g., internal power supply, display device and/or user interface device), and, thus, such component(s) of apparatus 1110 and apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more CISC or RISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including those pertaining to quantization for AI/ML models in wireless communications in accordance with various implementations of the present disclosure.

In some implementations, apparatus 1110 may also include a transceiver 1116 coupled to processor 1112. Transceiver 1116 may be capable of wirelessly transmitting and receiving data. In some implementations, transceiver 1116 may be capable of wirelessly communicating with different types of wireless networks of different radio access technologies (RATs). In some implementations, transceiver 1116 may be equipped with a plurality of antenna ports (not shown) such as, for example, four antenna ports. That is, transceiver 1116 may be equipped with multiple transmit antennas and multiple receive antennas for multiple-input multiple-output (MIMO) wireless communications. In some implementations, apparatus 1120 may also include a transceiver 1126 coupled to processor 1122. Transceiver 1126 may include a transceiver capable of wirelessly transmitting and receiving data. In some implementations, transceiver 1126 may be capable of wirelessly communicating with different types of UEs/wireless networks of different RATs. In some implementations, transceiver 1126 may be equipped with a plurality of antenna ports (not shown) such as, for example, four antenna ports. That is, transceiver 1126 may be equipped with multiple transmit antennas and multiple receive antennas for MIMO wireless communications.

In some implementations, apparatus 1110 may further include a memory 1114 coupled to processor 1112 and capable of being accessed by processor 1112 and storing data therein. In some implementations, apparatus 1120 may further include a memory 1124 coupled to processor 1122 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of apparatus 1110 and apparatus 1120 may be a communication entity capable of communicating with each other using various proposed schemes in accordance with the present disclosure. For illustrative purposes and without limitation, a description of capabilities of apparatus 1110, as a UE (e.g., UE 110), and apparatus 1120, as a network node (e.g., network node 125) of a network (e.g., network 130 as a 5G/NR mobile network), is provided below in the context of example process 1200.

### Illustrative Processes

FIG. 12 illustrates an example process 1200 in accordance with an implementation of the present disclosure. Process 1200 may represent an aspect of implementing various proposed designs, concepts, schemes, systems and methods described above pertaining to quantization for AI/ML models in wireless communications, whether partially or entirely, including those pertaining to those described above. Process 1200 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 1200 may be implemented by or in apparatus 1110 and/or apparatus 1120 as well as any variations thereof. Solely for illustrative purposes and without limiting the scope, each process is described below in the context of apparatus 1110 as a UE (e.g., UE 110) and apparatus 1120 as a communication entity such as a network node or base station (e.g., terrestrial network node 120) of a network (e.g., a 5G/NR mobile network). Process 1200 may begin at block 1210.

At 1210, process 1200 may involve processor 1112 of apparatus 1110 (e.g., as UE 110) performing quantization with respect to an AI/ML model (e.g., alone or together with apparatus 1120 as terrestrial network node 125 or non-terrestrial network node 128). Process 1200 may proceed from 1210 to 1220.

At 1220, process 1200 may involve processor 1112 performing, via transceiver 1116, a wireless communication by utilizing the AI/ML model.

In some implementations, in performing the quantization, process 1200 may involve processor 1112 performing one or more of the following: (i) quantization in a latent space; (ii) quantization in a gradient space; and (iii) quantization in a data space.

In some implementations, the quantization in the latent space may involve compacting representation of one or more latent vectors in a forward pass of a training stage and an inference stage.

In some implementations, the quantization in the latent space may involve a quantization stage and a dequantization stage.

In some implementations, the quantization stage may involve: (i) a generation part of the AI/ML model constructing a latent vector of a parameter; and (ii) a quantizer module converting the latent vector into a finite number of bits of a bit stream. Moreover, the dequantization stage may involve: (i) a dequantizer recovering the latent vector from the bit stream; and (ii) a reconstruction part of the AI/ML model recovering the parameter.

In some implementations, the quantization in the latent space may involve a TNA quantization in which the AI/ML model is exposed to quantization in a FP of an inference stage.

In some implementations, the quantization in the latent space may involve a TA quantization in which the AI/ML model is exposed to quantization in an inference stage.

In some implementations, the TA quantization may involve raising training awareness of quantization in a backpropagation by performing one or more of the following: (a) approximation of a quantization function with differentiable functions; (b) approximation of a gradient of the quantization function so that the BP is approximated at non-differentiable points; and (c) artificial gradient for quantization by replacing the gradient of the quantization function with a constant over an entire domain.

In some implementations, the TA quantization may involve a learnable quantization or a non-learnable quantization. In some implementations, the learnable quantization may pose a configuration or parameter which is adjusted during a training stage. Moreover, the non-learnable quantization may involve a fixed uniform quantization with intervals and levels that remain unchanged during the training stage.

In some implementations, the quantization in the latent space may involve SQ in which an element of a latent vector is mapped to a new discretized element. Alternatively, or additionally, the quantization in the latent space may involve VQ in which a latent vector is mapped to a new discretized vector. Alternatively, or additionally, the quantization in the latent space may involve segmented vector quantization in which a latent vector is broken down into multiple segments with each segments subjected to VQ.

In some implementations, the quantization in the latent space may involve segmented vector quantization. In some implementations, the segmented vector quantization may involve: (a) breaking down one or more training latent vectors into a plurality of segments with a respective VQ codebook corresponding to each of the segments; (b) applying a same segmentation in an inference stage; (c) assigning a respective codeword to each segment of the plurality of segments in the inference stage to result in a plurality of codewords; (d) concatenating the codewords of the plurality of segments in the inference stage to provide a final codeword; and (e) mapping the final codeword into a bit stream.

In some implementations, the quantization in the latent space may involve inference of the AI/ML model, which is a two-sided AI/ML model, with latent quantization. In some implementations, the inference of the two-sided AI/ML model with latent quantization may involve: (a) measuring an input; (b) providing a result of the measuring to an encoder which outputs an original latent; (c) applying quantization to the original latent; (d) generating a codeword;

dequantizing the codeword to result in a dequantized codeword; and (e) providing the dequantized codeword to a decoder to result in an output.

In some implementations, the quantization in the gradient space may involve compacting representation of one or more gradient vectors in a backpropagation of a training stage.

In some implementations, the quantization in the data space may involve compacting samples by quantizing a dataset to facilitate data collection with a lower overhead.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, quantization with respect to an artificial intelligence (AI)/machine learning (ML) model; and
performing, by the processor, a wireless communication by utilizing the AI/ML model.

2. The method of claim 1, wherein the performing of the quantization comprises performing one or more of:
quantization in a latent space;
quantization in a gradient space; and
quantization in a data space.

3. The method of claim 2, wherein the quantization in the latent space comprises compacting representation of one or more latent vectors in a forward pass of a training stage and an inference stage.

4. The method of claim 2, wherein the quantization in the latent space comprises a quantization stage and a dequantization stage.

5. The method of claim 4, wherein:
the quantization stage involves:
a generation part of the AI/ML model constructing a latent vector of a parameter; and
a quantizer module converting the latent vector into a finite number of bits of a bit stream, and
the dequantization stage involves:
a dequantizer recovering the latent vector from the bit stream; and
a reconstruction part of the AI/ML model recovering the parameter.

6. The method of claim 2, wherein the quantization in the latent space comprises a training-non-aware (TNA) quantization in which the AI/ML model is exposed to quantization in a forward pass (FP) of an inference stage.

7. The method of claim 2, wherein the quantization in the latent space comprises a training-aware (TA) quantization in which the AI/ML model is exposed to quantization in an inference stage.

8. The method of claim 7, wherein the TA quantization comprises raising training awareness of quantization in a backpropagation by performing one or more of:
approximation of a quantization function with differentiable functions;
approximation of a gradient of the quantization function so that the BP is approximated at non-differentiable points; and
artificial gradient for quantization by replacing the gradient of the quantization function with a constant over an entire domain.

9. The method of claim 7, wherein the TA quantization comprises a learnable quantization or a non-learnable quantization, wherein the learnable quantization poses a configuration or parameter which is adjusted during a training stage, and wherein the non-learnable quantization comprises a fixed uniform quantization with intervals and levels that remain unchanged during the training stage.

10. The method of claim 2, wherein the quantization in the latent space comprises scalar quantization (SQ) in which an element of a latent vector is mapped to a new discretized element.

11. The method of claim 2, wherein the quantization in the latent space comprises vector quantization (VQ) in which a latent vector is mapped to a new discretized vector.

12. The method of claim 2, wherein the quantization in the latent space comprises segmented vector quantization in which a latent vector is broken down into multiple segments with each segments subjected to vector quantization (VQ).

13. The method of claim 2, wherein the quantization in the latent space comprises segmented vector quantization, and wherein the segmented vector quantization comprises:
breaking down one or more training latent vectors into a plurality of segments with a respective vector quantization (VQ) codebook corresponding to each of the segments;
applying a same segmentation in an inference stage;
assigning a respective codeword to each segment of the plurality of segments in the inference stage to result in a plurality of codewords;
concatenating the codewords of the plurality of segments in the inference stage to provide a final codeword; and
mapping the final codeword into a bit stream.

14. The method of claim 2, wherein the quantization in the latent space comprises inference of the AI/ML model, which is a two-sided AI/ML model, with latent quantization.

15. The method of claim 14, wherein the inference of the two-sided AI/ML model with latent quantization comprises:
measuring an input;
providing a result of the measuring to an encoder which outputs an original latent;
applying quantization to the original latent;
generating a codeword;
dequantizing the codeword to result in a dequantized codeword; and
providing the dequantized codeword to a decoder to result in an output.

16. The method of claim 2, wherein the quantization in the gradient space comprises compacting representation of one or more gradient vectors in a backpropagation of a training stage.

17. The method of claim 2, wherein the quantization in the data space comprises compacting samples by quantizing a dataset to facilitate data collection with a lower overhead.

18. An apparatus, comprising:
a transceiver configured to communicate wirelessly; and
a processor coupled to the transceiver and configured to perform operations comprising:
performing quantization with respect to an artificial intelligence (AI)/machine learning (ML) model; and
performing, via the transceiver, a wireless communication by utilizing the AI/ML model.

19. The apparatus of claim 18, wherein the performing of the quantization comprises performing one or more of:
quantization in a latent space;
quantization in a gradient space; and
quantization in a data space.

20. The apparatus of claim 19, wherein the quantization in the latent space comprises:
a quantization stage involving:
a generation part of the AI/ML model constructing a latent vector of a parameter; and
a quantizer module converting the latent vector into a finite number of bits of a bit stream, and
a dequantization stage involving:
a dequantizer recovering the latent vector from the bit stream; and
a reconstruction part of the AI/ML model recovering the parameter.
